(19) United States
(12) Patent Application Publication
(10) Pub. No.: US 2024/0230901 A1
(43) Pub. Date: Jul. 11, 2024

(54) LIDAR-GYROSCOPE CHIP ASSEMBLIES

(71) Applicant: OSCPS MOTION SENSING INC., Montreal (CA)

(72) Inventors: Kazem ZANDI, Montreal (CA); Ramanand TEWARI, Ottawa (CA)

(21) Appl. No.: 18/559,826

(22) PCT Filed: May 11, 2022
(86) PCT No.: PCT/CA2022/050747

§ 371 Date: Nov. 9, 2023

Related U.S. Application Data
(60) Provisional application No. 63/186,961, filed on May 11, 2021.

(51) Int. Cl. G01S 17/26; G01C 19/72; G01S 7/481; G01S 17/931

(52) U.S. Cl. CPC G01S 17/26; G01C 19/721; G01C 19/725; G01S 7/4811; G01S 17/931

(57) ABSTRACT

The present disclosure provides a LIDAR-gyroscope chip assembly (also referred to as GIDAR) for autonomous vehicle navigation application. The chip assembly includes a silicon substrate, a LIDAR chip assembly disposed on the substrate, and a gyroscope disposed on the substrate in order to form one integrated sensing chip performing both inertial and LIDAR sensing. The single chip integration can be improved by using silicon nitride to form the LIDAR chip assembly components and the components of the gyroscope. Incorporating chip-based inertial measurement unit (IMU) and LIDAR system onto a single chip, leads to power, weight, and size reduction for autonomous vehicles navigation applications, especially for small drones and small robots where the vehicle is limited to size and power consumption. Due to the full integration of all elements onto one chip, the devices as described herein will be less sensitive to environmental perturbations such as shocks and vibrations compared to conventional devices.

### CROSS-REFERENCE

The present application claims priority to U.S. Provisional Patent Application No. 63/186,961, entitled “Lidar-Inertial Measurement Unit Chip Assemblies and Phase Modulator for an Optical Gyroscope,” filed on May 11, 2021, the entirety of which is incorporated herein by reference.

### TECHNICAL FIELD

The present technology generally relates to inertial sensors on a chip and related assemblies.

### BACKGROUND

As remote controlled and autonomous vehicles (such as drones) become more common, there is increasing interest in gyroscopes as sensors for measuring angular rotation. One type of gyroscope in the field of measuring angular velocity is optical gyroscopes, where the effect of rotation on light signals are monitored to detect rotational speed of an apparatus. In such devices, a light phase shift due to Sagnac effect is used to measure angular velocity.

LIDAR systems are also of increasing interest for autonomous vehicles in order to assist with navigation, steering, and obstacle and surrounding detection. As such autonomous vehicles need to become smaller and/or lighter, there is an increasing desire for smaller versions of LIDAR systems. The multiplication of different sensing systems in a smaller and/or lighter autonomous vehicle, for instance installing both LIDAR and gyroscopes or other inertial measurement systems, further complicates design of such autonomous vehicles.

There therefore remains a desire for advancements in LIDAR and/or inertial measurement systems.

### SUMMARY

It is an object of the present technology to ameliorate at least some of the inconveniences present in the prior art.

For automated or self-driven devices, LIDAR systems are often used for direction, steering, and obstacle detection. For devices of small dimensions or that are airborne, such as drones, inclusion of multiple systems, such as LIDAR systems and inertial sensing systems, can be difficult due to the weight and volume added by each additional tool added to the device.

According to an aspect of the present disclosure, there is provided a LIDAR-gyroscope chip assembly (also referred to as GIDAR). The chip assembly includes a silicon substrate, a LIDAR chip assembly disposed on the substrate, and a gyroscope disposed on the substrate in order to form one integrated sensing chip performing both inertial and LIDAR sensing. In at least some embodiments, single chip integration can be improved by using silicon nitride to form the LIDAR chip assembly components and the components of the gyroscope.

In at least some cases, silicon nitride can provide improvements over silicon-based. For example, improvement can be due at least in part to low nonlinearity, low propagation loss, and low index contrast characteristics of silicon nitride, as compared to silicon. The low nonlinearity characteristics aid in handling high power requirements of the LIDAR assembly. Low propagation loss makes silicon nitride a suitable candidate for both LIDAR and gyroscope applications. Lastly, the low index contrast of silicon nitride compared to silicon may lead to more flexible manufacturing and at least some reduction in fabrication-induced phase errors, important for both LIDAR and gyroscope assemblies.

By incorporating chip-based inertial sensing systems and LIDAR system onto a single chip, weight and space used by the tools is decreased. Due to the full integration of all elements onto one chip, the devices as described herein may also be insensitive or less sensitive to environmental perturbations such as shocks and vibrations. Integrating the components onto the chip, in certain embodiments, could result in reduction of noise and, therefore, better performance and reliability, compared to a system formed from conventional bulk LIDAR and inertial sensing systems. The costliest part of a photonics sensor is often the laser source. As both the gyroscope and the LIDAR can share the same laser in some embodiments, total cost could in some cases be significantly reduced.

According to one aspect of the present technology, there is provided a LIDAR-gyroscope chip assembly including a substrate; an optical gyroscope disposed on the substrate; and a LIDAR chip assembly disposed on the substrate.

In some embodiments, the substrate is formed from silicon; the optical gyroscope is formed from silicon nitride; and the LIDAR chip assembly is formed from silicon nitride.

In some embodiments, the LIDAR-gyroscope chip assembly further includes a frequency modulated continuous wave (FMCW) laser; and the optical gyroscope is operatively connected to the FMCW laser for using the FMCW laser as a gyroscope light source; and the LIDAR chip assembly is operatively connected to the FMCW laser for using the FMCW laser as a LIDAR light source.

In some embodiments, the LIDAR-gyroscope chip assembly further includes at least one power splitter operatively connected between the FMCW laser, and the optical gyroscope and the LIDAR chip assembly for splitting light from the FMCW laser for coupling into a first waveguide optically connected to the optical gyroscope and a second waveguide optically connected to the LIDAR chip assembly.

In some embodiments, the at least one power splitter includes at least one 1×2 multimode interference (MMI) coupler.

In some embodiments, the at least one 1×2 MMI coupler is configured to send at least half of laser power received from the FMCW laser to the LIDAR chip assembly.

In some embodiments, the at least one 1×2 MMI coupler is configured to split power received from the FMCW laser in at least one of: an in-plane distribution where the optical gyroscope and the LIDAR chip assembly are disposed in a same plane parallel to a surface of the substrate; and a split-plane distribution where the optical gyroscope and the LIDAR chip assembly are disposed in different planes parallel to the surface of the substrate.

In some embodiments, the FMCW laser is coupled to the optical gyroscope and the LIDAR chip assembly through the at least one spot size converter.

In some embodiments, the FMCW laser is disposed on the substrate, the FMCW laser being flip-chip bonded to the substrate.

In some embodiments, the FMCW laser is configured to emit light in a wavelength band of about 1500 nm to about 1700 nm.

In some embodiments, the LIDAR-gyroscope chip assembly further includes a wavelength-stabilized laser disposed on the substrate; a frequency modulated continuous wave (FMCW) laser disposed on the substrate; and the optical gyroscope is operatively connected to the wavelength-stabilized laser for using the wavelength-stabilized laser as a gyroscope light source; and the LIDAR chip assembly is operatively connected to the FMCW laser for using the FMCW laser as a LIDAR light source.

In some embodiments, the wavelength-stabilized laser is optically coupled to the optical gyroscope through at least one first spot size converter; and the FMCW laser is optically coupled to the LIDAR chip assembly through at least one second spot size converter.

In some embodiments, the FMCW laser and the wavelength-stabilized laser are disposed on the substrate, the FMCW laser and the wavelength-stabilized laser being flip-chip bonded to the substrate.

In some embodiments, the wavelength-stabilized laser is configured to emit light at a wavelength of about 1550 nm; and the FMCW laser is configured to emit light in a wavelength band of about 1500 nm to about 1700 nm.

In some embodiments, the LIDAR chip assembly includes a transmitter phase shifter assembly disposed on the substrate, and a receiver phase shifter assembly disposed on the substrate; the transmitter phase shifter assembly and the receiver phase shifter assembly are formed from at least one of lithium niobate, and lead zirconate titanate (PZT).

In some embodiments, the transmitter phase shifter assembly and the receiver phase shifter assembly are configured to be controlled by one of thermal tuning; and electro-optical tuning.

In some embodiments, at least one of the transmitter phase shifter assembly and the receiver phase shifter assembly comprises a plurality of electrodes; a plurality of gaps are defined between the plurality of electrodes; and the plurality of gaps are arranged to reduce voltage overlap between the plurality of electrodes.

In some embodiments, the LIDAR-gyroscope chip assembly further includes a coherent detector operatively connected to the LIDAR chip assembly.

In some embodiments, the coherent detector is optically coupled to the LIDAR chip assembly through a detector-side spot size converter.

In some embodiments, the coherent detector is wafer bounded to the substrate.

In some embodiments, the optical gyroscope further comprises at least one sensing element; the at least one sensing element comprises a plurality of vertically stacked spiral resonators; and the plurality of vertically stacked spiral resonators are optically inter-coupled.

In some embodiments, the optical gyroscope and the LIDAR chip assembly are disposed in a same plane, the plane being parallel to a surface of the substrate.

In some embodiments, the optical gyroscope and the LIDAR chip assembly are disposed in a vertically stacked arrangement.

In some embodiments, the LIDAR chip assembly is disposed vertically above the optical gyroscope.

According to another aspect of the present technology, there is provided a phase modulator including at least some cross-sectional area of epsilon-near-zero (ENZ) material for selectively controlling the phase of light, the material being configured to absorb TM polarized light and modify phase of TE polarized light.

According to another aspect of the present technology, there is provided a stack of spiral shape ring resonators coupled vertically to each other using grating couplers forming the sensing element of gyro (measuring Sagnac effect).

It should be understood that at least some of the elements described herein could be fabricated by deposition. Chemical deposition and other deposition techniques such as layer bonding, as described herein, of various layers on the substrate and other layers provides immovable attachment of the layers to the substrate and the other layers, respectively.

The term “deposit” in reference to fabrications methods, as used herein, refers broadly to methods and processes of mechanically and/or chemically applying a material to one or more desired locations, or as a layer, on a surface. The methods and processes encompassed by the term “deposit” herein include but are not limited to: spin-coating, photo-resist development and etching, photolithography, electron-beam lithography, thermal oxidation, plasma etching, low pressure chemical vapor deposition, plasma enhanced chemical vapor deposition, and physical vapor deposition.

Quantities or values recited herein are meant to refer to the actual given value. The term “about” is used herein to refer to the approximation to such given value that would reasonably be inferred based on the ordinary skill in the art, including equivalents and approximations due to the experimental and/or measurement conditions for such given value.

Embodiments of the present disclosure each have at least one of the above-mentioned objects and/or aspects, but do not necessarily have all of them. It should be understood that some aspects of the present disclosure that have resulted from attempting to attain the above-mentioned object may not satisfy this object and/or may satisfy other objects not specifically recited herein.

Additional and/or alternative features, aspects and advantages of embodiments of the present disclosure will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a top plan schematic view of a LIDAR-gyroscope chip assembly according to one non-limiting embodiment of the present technology;

FIG. 2 is a top plan schematic view of a LIDAR-gyroscope chip assembly according to another non-limiting embodiment of the present technology;

FIG. 3 is a top plan schematic view of a LIDAR-gyroscope chip assembly according to yet another non-limiting embodiment of the present technology;

FIG. 4 is a top plan schematic view of a LIDAR-gyroscope chip assembly according to yet another non-limiting embodiment of the present technology;

FIG. 5 is a perspective schematic view of a LIDAR-gyroscope chip assembly according to yet another non-limiting embodiment of the present technology;

FIG. 6 is a schematic diagram of a LIDAR chip assembly of the LIDAR-gyroscope chip assemblies of FIGS. 1 to 5;

FIG. 7 is a diagram of a transmitter optical phased array and a receiver optical phased array of the LIDAR chip assembly of FIG. 6;

FIG. 8 is a diagram of a power splitter of the transmitter optical phased array and the receiver optical phased array of FIG. 7;

FIG. 9 is an optical phase shifter of the transmitter optical phased array and the receiver optical phased array of FIG. 7, according to one non-limiting embodiment of the present technology;

FIG. 10 is an optical phase shifter according to another non-limiting embodiment of the present technology;

FIG. 11 is an optical phase shifter according to yet another non-limiting embodiment of the present technology;

FIG. 12 is an optical phase shifter according to yet another non-limiting embodiment of the present technology;

FIG. 13 is an optical phase shifter according to yet another non-limiting embodiment of the present technology;

FIG. 14 is a side perspective schematic view of portions of the optical phase shifter of FIG. 9;

FIG. 15 is a schematic top plan view of a grating emitter of the optical phased array of FIG. 7;

FIG. 16 is a graph illustrating a simulated effective index over wavelength for silicon nitride waveguide used in the grating emitter of FIG. 15;

FIG. 17 is a graph illustrating a simulated vertical beam angle over wavelength of the grating emitter of FIG. 15;

FIG. 18 is a graph illustrating a simulated vertical beam steering angle over wavelength of the grating emitter of FIG. 15;

FIG. 19 is a perspective schematic view of a stack of spiral shape ring resonators of a gyroscope chip assembly of the LIDAR-gyroscope chip assemblies of FIGS. 1 to 5;

FIG. 20 is a cross-sectional view of the stack of resonators of FIG. 19;

FIG. 21 is a perspective schematic view of a phase modulator according to one non-limiting embodiment of the present technology and as used in some embodiments of the assembly of FIG. 1;

FIG. 22 illustrates top and side views of the phase modulator of FIG. 21;

FIGS. 23 and 24 illustrate example component characteristics of the phase modulator of FIG. 21;

FIG. 25 is a cross-sectional view of an epsilon-near-zero (ENZ) material-based phase modulator of the assembly of FIG. 1; and

FIG. 26 is a schematic side view of a gyroscope of an assembly according to the present technology.

It is to be understood that throughout the appended drawings and corresponding descriptions, like features are identified by like reference characters. Furthermore, it is also to be understood that the drawings and ensuing descriptions are intended for illustrative purposes only and that such disclosures do not provide a limitation on the scope of the claims. It should be noted that the Figures may not be drawn to scale, except where otherwise noted.

### DETAILED DESCRIPTION

The present disclosure is directed to systems, methods and apparatuses to address the deficiencies of the current state of the art.

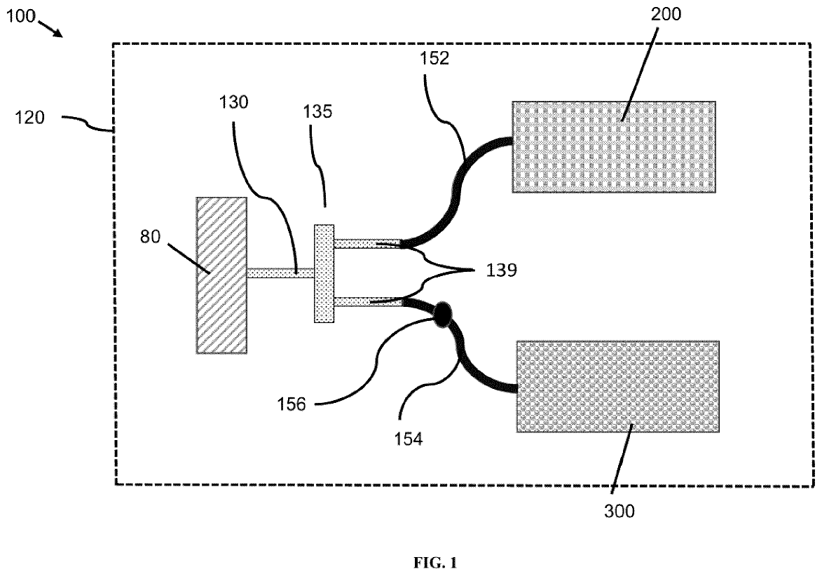

With reference to FIG. 1, there is illustrated a LIDAR-optical gyroscope (GIDAR) chip assembly 100, referred to herein as the assembly 100, according to at least some embodiments of the present technology. The assembly 100 includes a silicon/SOI substrate 120 on which are disposed the active or passive components of the assembly 100, including but not limited to: photodetectors, laser assemblies, waveguides, power splitters, gratings, and the like. Although not explicitly shown, it is noted that additional material and layers could be deposited around and/or over the substrate 120 and the additional components described herein. For example, materials for protecting components or packaging could be deposited over the chip containing the assembly 100, including but not limited to polymers.

The assembly 100, as arranged on a chip (not shown) forms an integrated sensing chip performing both inertial and LIDAR sensing. The assembly 100 includes both an optical gyroscope 300 and a LIDAR chip assembly 200.

The optical gyroscope 300 is disposed on the substrate 120. Details of the gyroscope 300 could vary between different embodiments. Additional detail of at least some example gyroscopes can be found in International Patent Application No. PCT/CA2022/050031, filed 11 Jan. 2022, there entirety of which is incorporated herein by reference. The optical gyroscope 300 is formed from silicon nitride in the present embodiment. In at least some embodiments, accelerometers formed from Silicon could additionally or alternatively integrated in the assembly 100, such as those described in U.S. Pat. No. 10,126,321, issued on Nov. 13, 2018, the entirety of which is incorporated herein by reference.

The assembly 100 also includes a LIDAR chip assembly 200 attached to the substrate 120. Components of the LIDAR chip assembly 200 are formed from silicon nitride. Details and components of the LIDAR chip assembly 200, also referred to as the LIDAR assembly 200, are described in more detail below.

In the embodiment illustrated in FIG. 1, the optical gyroscope 300 and the LIDAR chip assembly 200 are disposed in a same plane generally parallel to a surface of the substrate 120. With this arrangement, the silicon nitride components of both the gyroscope 300 and the LIDAR assembly 200 are formed in a same fabrication step. In at least some cases, this can reduce alignment time and errors, facilitating fabrication of the assembly 100. In at least some case, the silicon nitride can be deposited, spun, and/or etched for both the gyroscope 300 and the LIDAR assembly 200 simultaneously.

The LIDAR-gyroscope chip assembly 100 further includes a tunable frequency modulated continuous wave (FMCW) laser 80, also referred to herein as the laser 80. The laser 80 is operatively and optically connected (described further below) to both of the gyroscope 300 and the LIDAR assembly 200 for providing light for operating both the gyroscope 300 and the LIDAR assembly 200. In the present embodiment, the FMCW laser 80 is configured to emit light in a wavelength band of about 1500 nm to about 1700 nm, with the laser 80 being tunable across the entirety of the wavelength band. In at least some cases, it is contemplated that the FMCW laser 80 could be tunable across a different wavelength band, for instance within a band 1271 nm to 1331 nm.

The laser 80 is connected to and disposed on the substrate 120. In the present embodiment, the laser 80 is flip-chip bonded to the substrate 120. It is contemplated that the laser 80 could be differently connected to the substrate 120. As is described below, the laser 80 could be provided separately from the substrate 120 in some cases.

The LIDAR-gyroscope chip assembly 100 further includes a power splitter 135 operatively connected between the FMCW laser 80, the optical gyroscope 300, and the LIDAR chip assembly 200. The power splitter 135 is configured for splitting light from the FMCW laser 80 in order to provide light for operation of both the gyroscope 300 and the LIDAR assembly 200. The splitter 135 includes a splitter input waveguide 130 optically connecting the laser 80 to the splitter 135. The waveguide 130 is formed from Silicon Nitride. Depending on the embodiment, the splitter 135 could be different operatively connected to the laser 80.

The splitter 135 couples into a first waveguide 154 optically connected to the optical gyroscope 300, such that the optical gyroscope 300 is operatively connected to the FMCW laser 80 for using the FMCW laser 80 as a gyroscope light source. Specifically, the splitter 135 includes a first Silicon Nitride splitter output waveguide 139 optically connected to the waveguide 154, also formed from Silicon Nitride.

As will be known to a person in the art, the gyroscope 300 requires a narrow bandwidth light source for operation. As the FMCW laser 80 has a generally wider bandwidth, the assembly further includes a 1550 nm narrow linewidth band-pass wavelength filter 156 between the FMCW laser 80 and the gyroscope 300. Depending on the embodiment, the band-pass filter 156 could be configured to transmit a different wavelength, for instance 1560 nm. The filter 156 is operatively connected to the waveguide 154, although it is contemplated that the filter 156 could be disposed elsewhere along the waveguide 154.

The splitter 135 also couples into a second waveguide 152 optically connected to the LIDAR chip assembly 200, such that the LIDAR chip assembly 200 is operatively connected to the FMCW laser 80 for using the FMCW laser 80 as a LIDAR light source. Specifically, the splitter 135 includes a second Silicon Nitride splitter output waveguide 139 optically connected to the waveguide 152, also formed from Silicon Nitride. It is contemplated that the splitter output waveguides 139 could be directly connected to the gyroscope 300 and the LIDAR assembly 200 in some cases.

While different types of chip-based optical splitters could be used, the power splitter 135 is a 1×2 multimode interference (MMI) coupler 135 in the illustrated embodiment. The 1×2 MMI coupler 135 is configured to send at least half of laser power received, at the coupler 135 from the FMCW laser 80, to the LIDAR chip assembly 200. The LIDAR chip assembly 200 generally requires as much, or more, laser power than the gyroscope 300. In some embodiments, the 1×2 MMI coupler 135 is configured to split power equally between the two waveguides 152, 154 (50:50 split). In other embodiments, the 1×2 MMI coupler 135 is configured to split power such that more power is diverted to the waveguide 152 in order to provide more than 50% of the received laser power to the LIDAR chip assembly 200. Specifically, the 1×2 MMI coupler 135 could be arranged in an X:Y split, X>Y, X being the power transmitted to the LIDAR assembly 200 and Y being power transmitted to the gyroscope 300. The coupler 135 is configured to split the laser power in an in-plane distribution where the optical gyroscope 300 and the LIDAR chip assembly 200 are disposed in a same plane parallel to a surface of the substrate 120.

While not shown explicitly herein, it is contemplated that the assembly 100 could be provided with additional components, such as photodetector assemblies, detectors, wavelength filters, spot size converters, attenuators, waveguide prism reflectors. In some other non-limiting embodiments, active layers to form embodiments of photodetectors, laser assemblies, and the like could be directly deposited on the substate 120 during fabrication, for example by defining the active layers through photolithography and etching.

The assembly 100, and different embodiments of assemblies described below, also include waveguide structures and other optical elements to direct and manage light propagation between different components, for example between the laser 80, the LIDAR assembly 200, and the gyroscope 300. These optical elements could include, but are not limited to, waveguides, polarizers, circulators, and couplers.

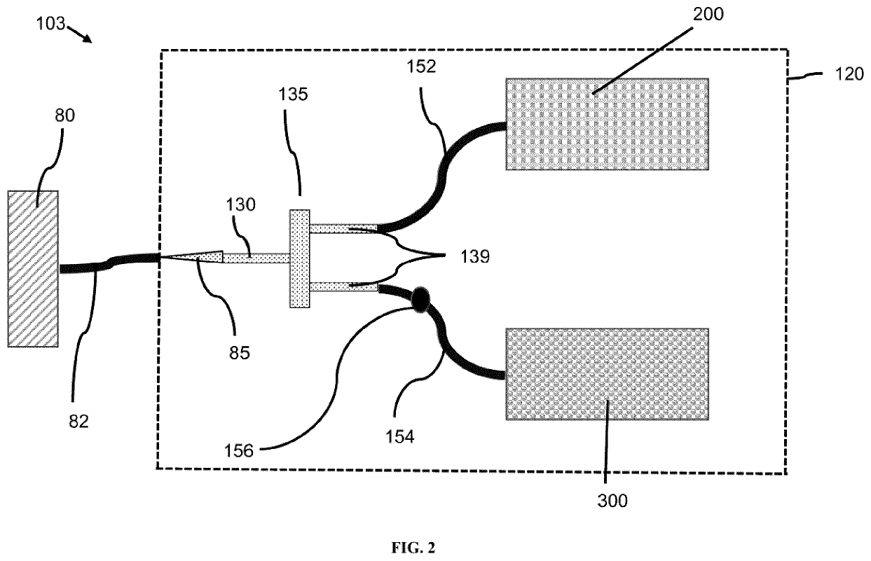

Another embodiment of a LIDAR-gyroscope chip assembly 103 according to the present technology is illustrated in FIG. 2. Elements of the chip assembly 103 that are similar to those of the chip assembly 100 retain the same reference numeral and will generally not be described again.

In the assembly 103, the FMCW laser 80 is disposed external to the substrate 120. The assembly 103 thus further includes a spot size converter 85 disposed on the substrate 120 and optically connected to the splitter input waveguide 130. A single mode polarization-maintaining (PM) fiber 82 is included and optically connected between the laser 80 and the spot size converter 85. The externally disposed laser 80 is thus coupled to the optical gyroscope 300 and the LIDAR chip assembly 200 through the spot size converter 85.

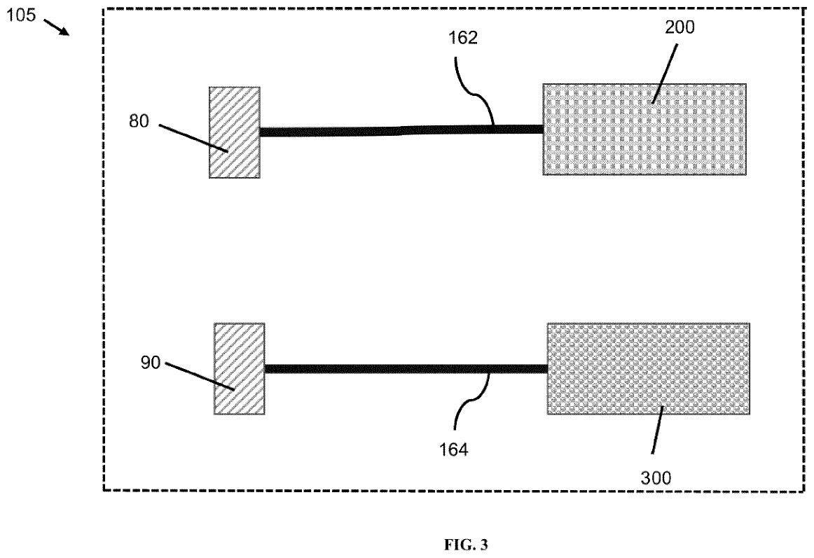

Yet another embodiment of a LIDAR-gyroscope chip assembly 105 according to the present technology is illustrated in FIG. 3. Elements of the chip assembly 105 that are similar to those of the chip assembly 100 retain the same reference numeral and will generally not be described again.

In addition to the laser 80, the LIDAR-gyroscope chip assembly 105 further includes a wavelength-stabilized laser 90 disposed on the substrate 120, also referred to as the laser 90. The laser 90 is configured to emit light at a wavelength of about 1550 nm for use by the gyroscope 300 as a gyroscope light source. In this embodiment, the FMCW laser 80 and the wavelength-stabilized laser 90 are disposed on the substrate 120 and more specifically flip-chip bonded to the substrate 120.

With a laser source included for each of the gyroscope 300 and the LIDAR assembly 200, the splitter 135 is omitted in the embodiment of the assembly 105. The FMCW laser 80 is optically connected to the LIDAR assembly 200 by a Silicon Nitride waveguide 162. The wavelength-stabilized laser 90 is optically connected to the gyroscope 300 by a Silicon Nitride waveguide 164. As the laser 90 operates with a narrow wavelength, there is also no filter included.

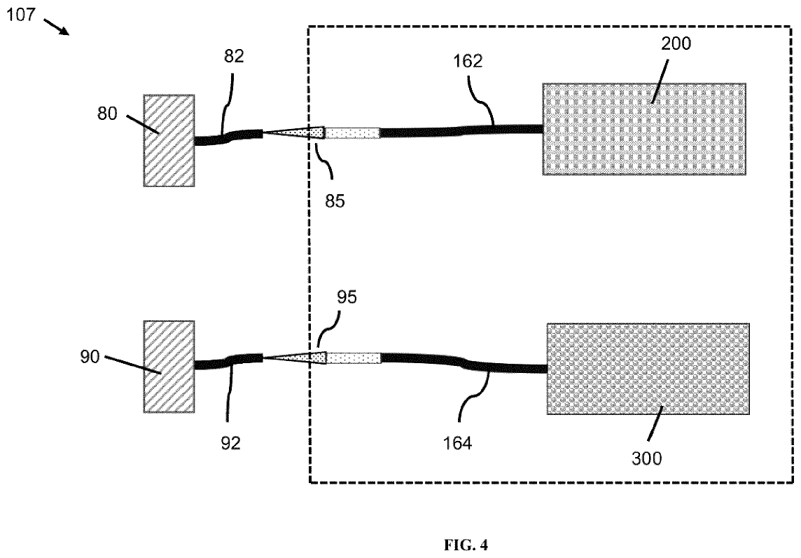

Yet another embodiment of a LIDAR-gyroscope chip assembly 107 according to the present technology is illustrated in FIG. 4. Elements of the chip assembly 107 that are similar to those of the chip assemblies 100 and 105 retain the same reference numeral and will generally not be described again.

In the assembly 107, the FMCW laser 80 and the wavelength-stabilized laser 90 are provided external to the substrate 120, similar to the embodiment of the assembly 103. The wavelength-stabilized laser 90 is optically coupled to the optical gyroscope 300 through a first spot size converter 95. A single mode PM fiber 92 is included to connect the laser 90 to the spot converter 95. The FMCW laser 80 is similarly optically coupled to the LIDAR chip assembly 200 through a second spot size converter 85, via the single mode PM fiber 82.

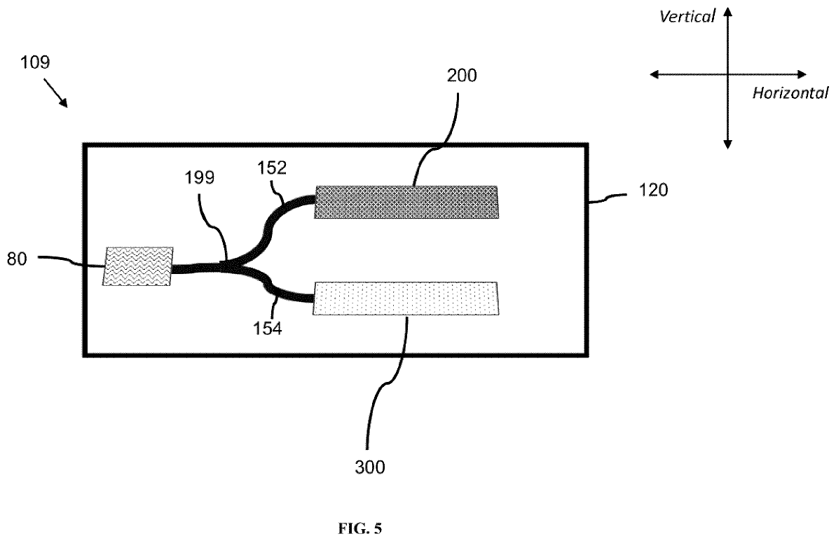

Yet another embodiment of a LIDAR-gyroscope chip assembly 109 according to the present technology is illustrated in FIG. 5. Elements of the chip assembly 109 that are similar to those of the chip assembly 100 retain the same reference numeral and will generally not be described again.

The assembly 109 is illustrated from a perspective, side view to reveal a vertically stacked arrangement of the LIDAR chip assembly 200 and the optical gyroscope 300 in this embodiment. Rather than being arranged in a same plane parallel to a substrate surface (as is the case for assemblies 100, 103, 105, 107), the optical gyroscope 300 and the LIDAR chip assembly 200 are disposed in a vertically stacked arrangement. The LIDAR chip assembly 200 is disposed vertically above the optical gyroscope 300.

The assembly 109 also includes a 1×2 vertical coupler 199 connected between the FMCW laser 80 and the waveguides 152, 154 in order to split optical power between the optical gyroscope 300 and the LIDAR chip assembly 200. The coupler 199 is configured to split power in a split-plane distribution where the optical gyroscope 300 and the LIDAR chip assembly 200 are disposed in different, vertically separated planes parallel to the surface of the substrate 120.

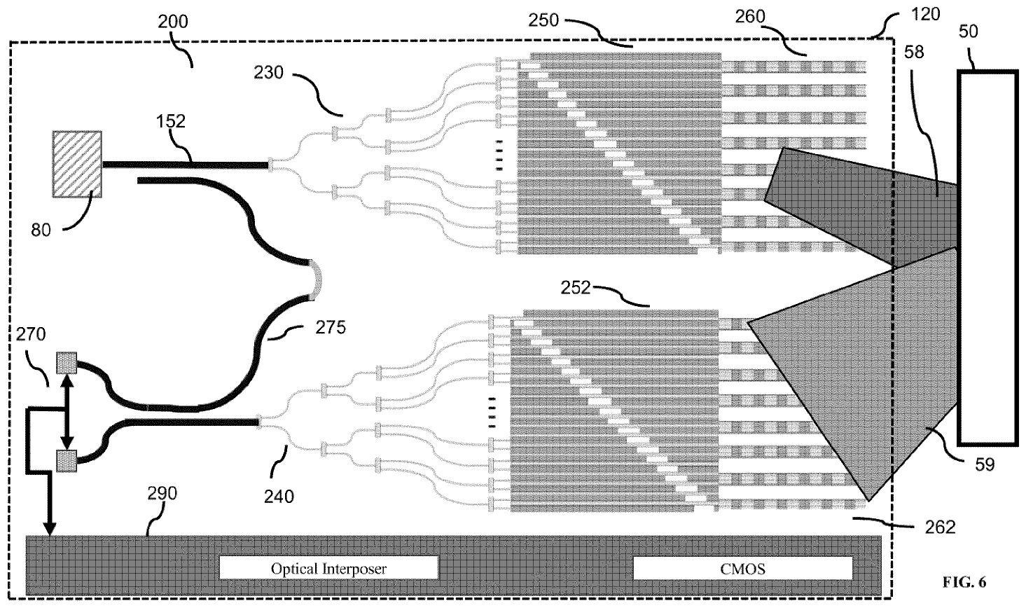

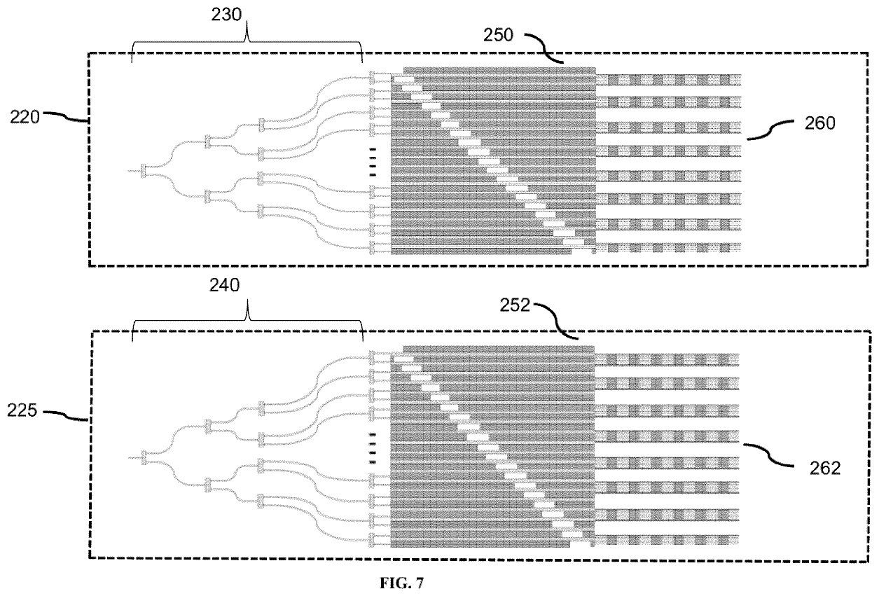

With reference to FIGS. 6 to 8, the LIDAR chip assembly 200 of the above described LIDAR-gyroscope assemblies 100, 103, 105, 107, 109 will now be described in more detail.

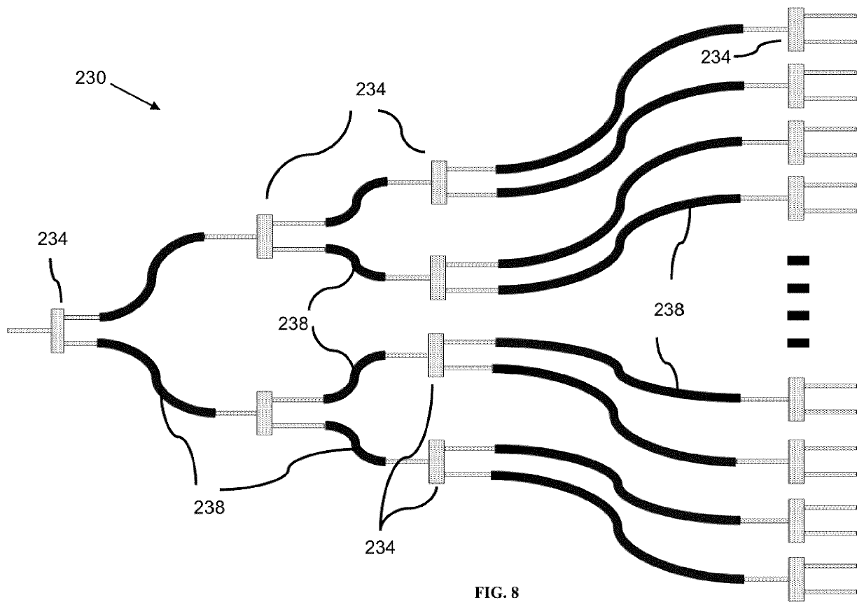

The LIDAR assembly 200 receives light from the waveguide 152, as described above, at a transmitter optical phased array 220. The optical phased array 220 includes a 1×N MMI Silicon Nitride power splitter 230 optically connected to the waveguide 152. Shown in more detail in FIG. 8, the splitter 230 includes a series of cascaded 1×2 MMI Silicon Nitride power splitters 234 interconnected by a plurality of Silicon Nitride optical waveguides 238. Depending on the embodiment, the total number (N) of splitters could be more or less than the illustrated assembly of the splitter 230.

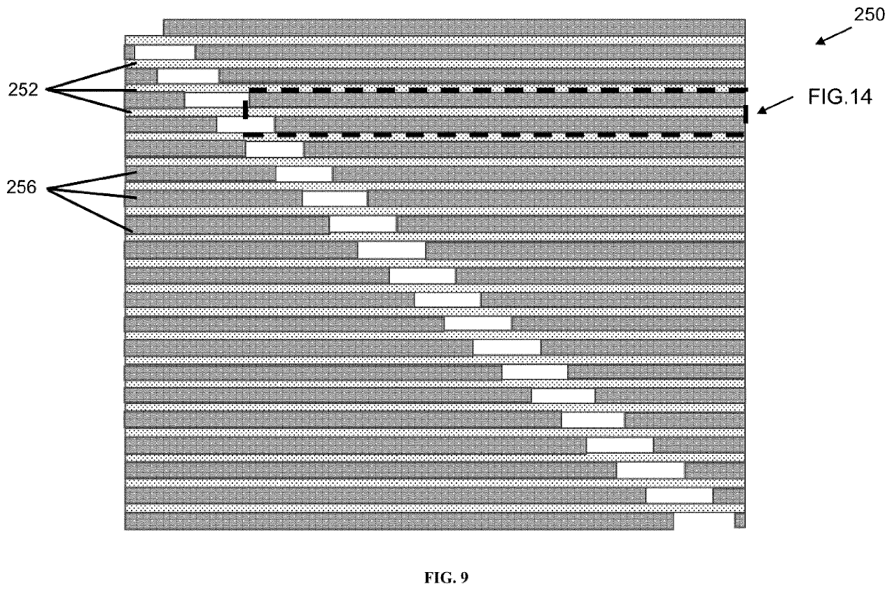

Light from the waveguides 238 is propagated to a transmitter optical phase shifter assembly 250, referred to herein as the transmitter phase shifter 250, disposed on the substrate 120 of the optical phased array 220. The optical phase shifter 250 is illustrated in more detail in FIG. 9. The phase shifter 250 includes a repeating series of phase shifting members 252 and electrodes 256. Depending on the embodiment, the phase shifting members 252, also referred to as waveguides 252, are formed from Lithium Niobate or Lead Zirconate Titanate (PZT). The electrodes 256 can be formed from a variety of materials, depending on the particular embodiment. The material of the electrodes 256 could include, but is not limited to, Platinum, Copper, Palladium, Titanium Nitride (TiN), and Titanium. In the illustrated embodiment, the transmitter phase shifter assembly 250 is configured to be controlled by one of thermal tuning and electro-optical tuning.

The phased array 220, as well as the phased array 225 described further below, are formed from a series of phase shifters arranged in parallel to each other. The phase in phase shifters can be varied or tuned by thermal heating the electrodes or applying the voltage across the electrodes which results in the changing of refractive indices in the area below or between the electrodes and thereby resulting in the phase shifting of the guided light, thereby steering the emitted beam in two horizontal directions.

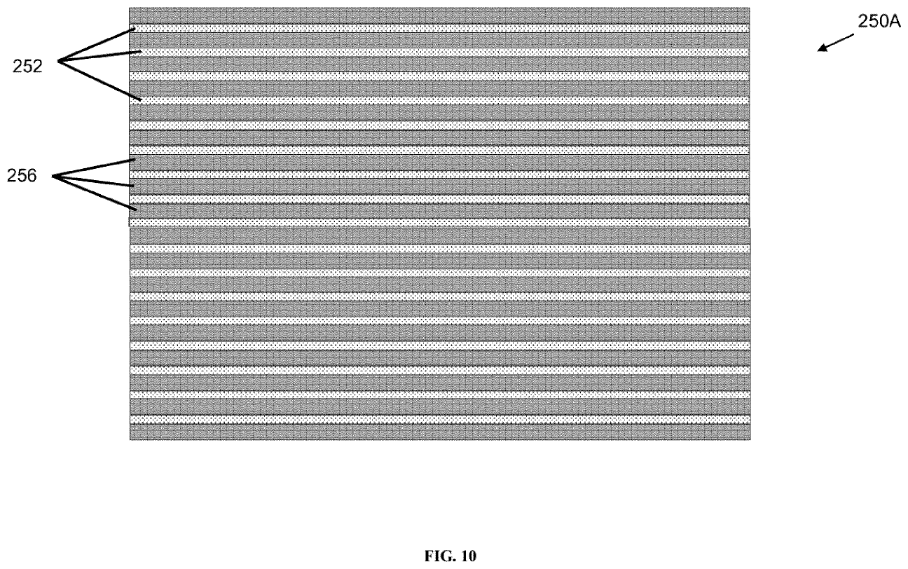

FIG. 10 illustrates another embodiment of an optical phase shifter 250A that could be implemented in the phased arrays 220, 225. In the embodiment of FIG. 10, an unequal voltage is applied across the electrodes 256 to provide beam steering in at least one horizontal direction.

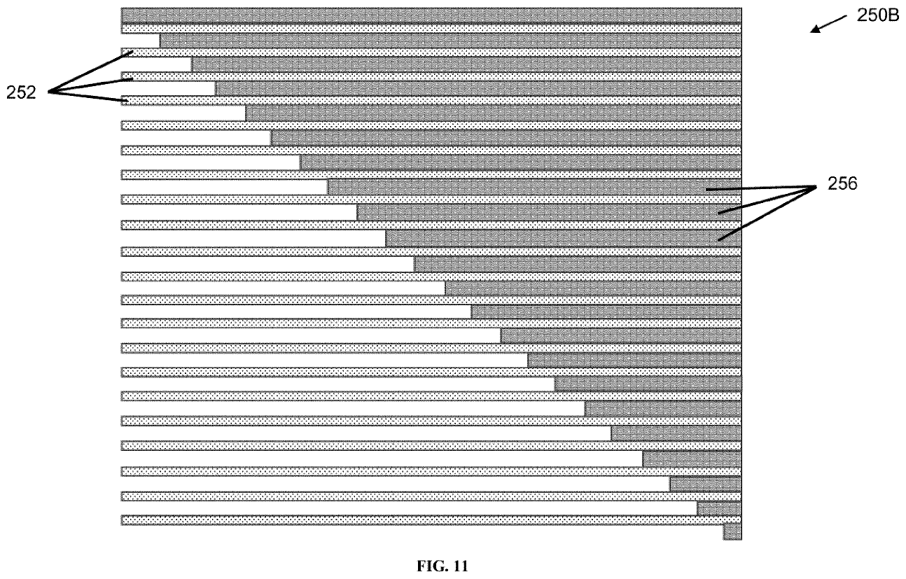

FIG. 11 illustrates yet another embodiment of an optical phase shifter 250B that could be implemented in the phased arrays 220, 225. In the embodiment of FIG. 11, an equal voltage is applied across the electrodes 256 for steering and receiving the beam in at least one horizontal direction.

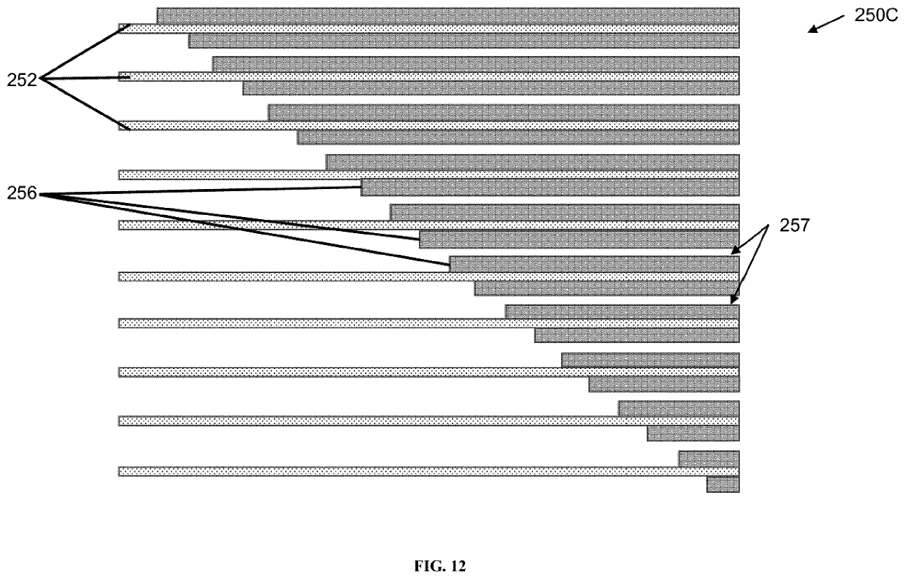

FIG. 12 illustrates yet another embodiment of an optical phase shifter 250C that could be implemented in the phased arrays 220, 225. In the embodiment of FIG. 12, an equal voltage is applied across the electrodes 256 for steering and receiving the beam in at least one horizontal direction. The phase shifting members 252 and the electrodes 256 are arranged to define gaps 257 to avoid overlapping of applied voltage to the neighboring waveguides/phase shifting members 252.

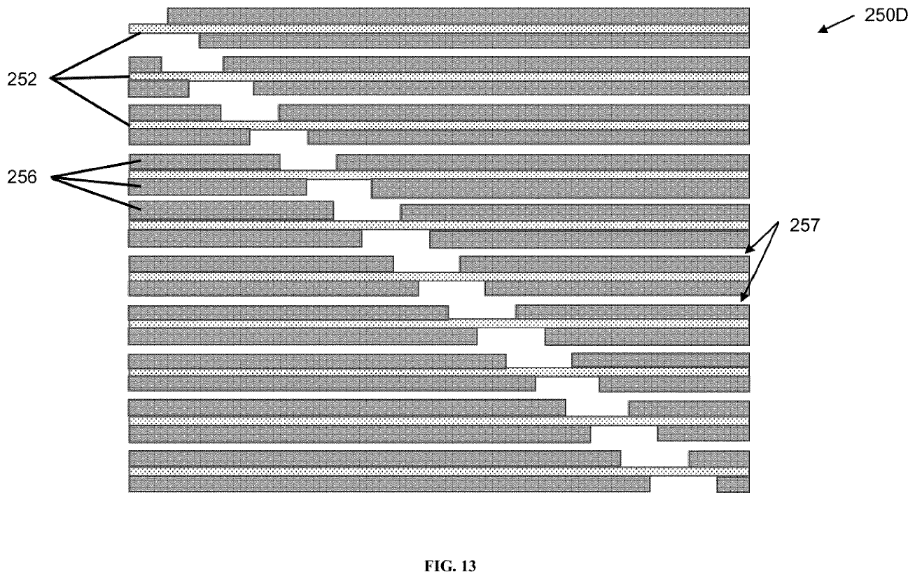

FIG. 13 illustrates yet another embodiment of an optical phase shifter 250D that could be implemented in the phased arrays 220, 225. In the embodiment of FIG. 13, an equal voltage is applied across the electrodes 256 for steering and receiving the beam in two horizontal directions. The phase shifting members 252 and the electrodes 256 are arranged to define gaps 257 to avoid overlapping of applied voltage to the neighboring waveguides/phase shifting members 252.

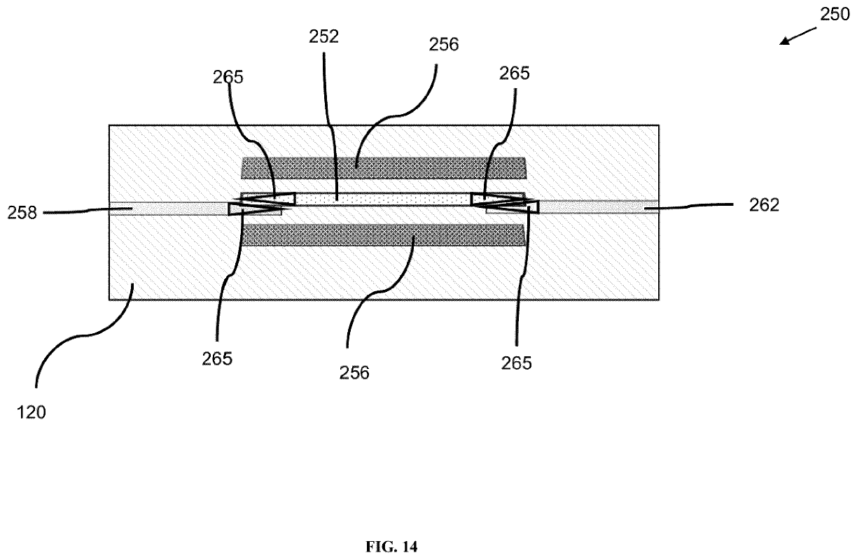

FIG. 14 further illustrates a perspective view of one possible layered arrangement, highlighted in FIG. 9, of the electrodes 256 and the phase shifting members 252, relative to an input waveguide 258 and an output waveguide 262.

Light from the lower input silicon nitride waveguide 258 is vertically coupled to the upper silicon nitride waveguide 252 by vertical evanescent coupling. The power coupled to the waveguide 252 can be varied by changing the vertical gap between the waveguides 258 and 252 and also by changing the length of the overlap region between the waveguides 258 and 252 in different embodiments. In a similar fashion, light can be coupled back to the lower silicon nitride waveguide 262 from the upper silicon nitride waveguide 252 by vertical evanescent coupling. The input silicon nitride waveguide 258 and the output silicon nitride waveguide 262 and the upper silicon nitride waveguide 252 are tapered, at least in some embodiments, as is illustrated by tapers 265 in order to provide efficient vertical coupling.

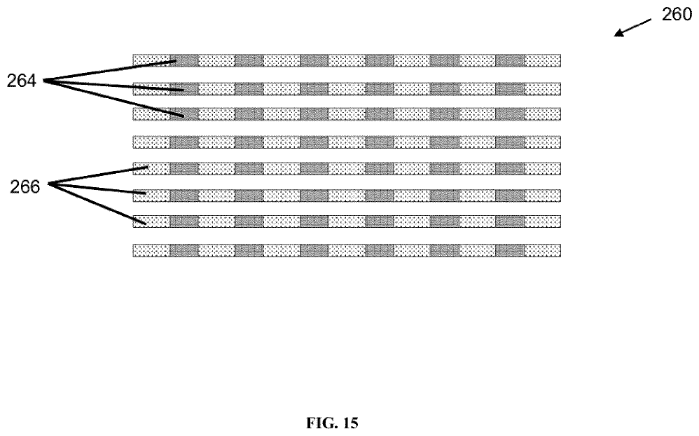

The transmitter optical phased array 220 further includes a Silicon Nitride grating emitter 260 optically coupled to the phase shifter 250, shown in isolation in FIG. 15. The grating emitter 260 is formed from a repeating series of Silicon Nitride blocks 264 and Silicon Dioxide blocks 266, arranged in parallel rows. Specifically, the grating emitter 260 is formed by periodic patterning of Silicon Nitride 264 and Silicon Dioxide 266. Periodic patterning of Silicon Oxynitride and Silicon Dioxide can also be performed to form the grating emitter 260.

Light received by the grating emitter 260 is steered by tuning FMCW laser 80 and by applying different voltages across the electrodes 256 of the transmitter optical phased array 250. Depending on the embodiment or use, voltages can be applied equally or unequally across the electrodes 256.

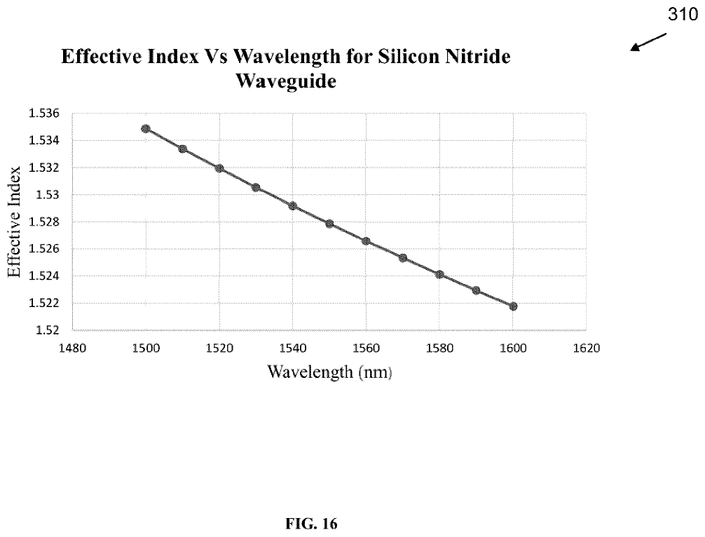

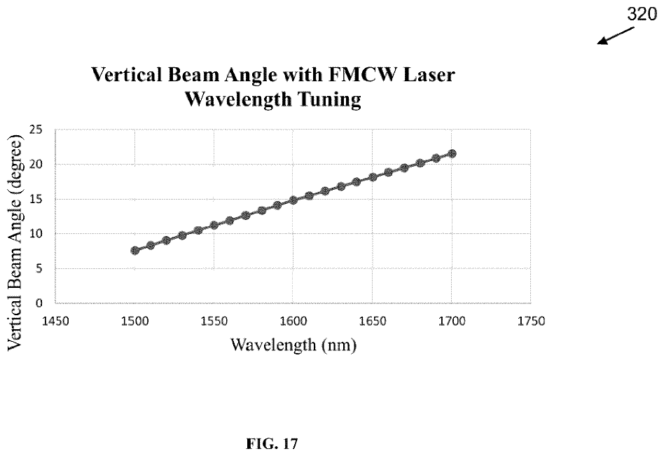

With reference to FIGS. 16 to 18, simulations relating the material properties, specifically dispersion properties of the materials, and scanning capability of the present embodiment of the LIDAR chip assembly 200 are illustrated. Silicon Nitride has been chosen for at least some of the present non-limiting embodiments, at least in part, in view of the smoothly varying effective index over the wavelength band of the FMCW laser 80. As can be seen in the graph 310 of FIG. 16, the effective index of Silicon Nitride varies from 1.535 to 1.522 over the wavelengths of 1500 nm to 1700 nm. For the illustrated simulations, the material dispersion properties of Silicon Nitride and Silicon Oxide have been taken into account for simulating the effective indices. Based on this effective index, graph 320 of FIG. 17 represents a simulation of the vertical beam angle emitted by the grating emitter 260. The vertical beam angle, as used herein, is defined as:

$$θ = {sin}^{- 1} \frac{{n}_{eff} Λ - λ}{Λ} ,$$

where, n_{eff} is the effective index of the waveguide within the grating 260, A is grating pitch and A is the emission wavelength.

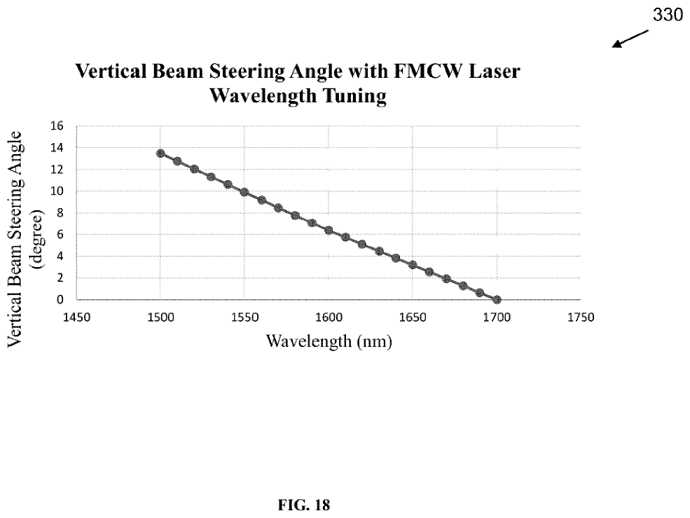

The vertical output beam angle, based on the present embodiment, then can vary between 7.5 degrees and 21.5 degrees, relative to horizontal, over the wavelength range (from 1500 nm to 1700 nm). Further illustrated by the simulation 330 of FIG. 18, the possible vertical beam steering angle can thus vary from 14 degrees to zero degrees. As used herein, the beam steering angle (O, is defined as:

$$δθ = δ {n}_{eff} - \frac{δλ}{Λ} .$$

Returning to FIG. 6, outgoing light 58 is scanned over the surroundings 50 per usual LIDAR scanning operation. At least some of the light incident on and reflected back from the surroundings 50, i.e. incoming light 59, is incident on a receiver optical phased array 225 of the LIDAR chip assembly 200.

Specifically, the received incoming light 59 is received by a Silicon Nitride grating receiver 262 of the receiver optical phased array 225. The grating receiver 262 is generally identical to the grating emitter 260 and as such will not be described in detail. It is contemplated that the gratings 260, 262 could have differences in some embodiments.

The receiver optical phased array 225 also includes a receiver optical phase shifter assembly 252, also referred to as the receiver phase shifter 252, optically coupled to the grating 262. The phase shifter 252 is identical to the phase shifter 250 and as such will not be described separately. It is also contemplated that phase shifters 250, 252 could have differences in some embodiments.

The receiver optical phased array 225 further includes a 1×N MMI Silicon Nitride power combiner 240. The combiner 240, identical in form to the splitter 230, is optically coupled to the phased array 225 in order to receive and recombine the optical signals therefrom.

With continued reference to FIG. 6, the assembly 100 further includes a coherent detector 270, communicatively connected to a computational device 290. The LIDAR assembly 200 is optically connected to the detector 270 through the combiner 240, such that the detector 270 and the computational device 290 are operable to determine a representation of the surroundings 50. A Silicon Nitride waveguide 275 is optically coupled between the coherent detector 270 and the laser 80, in order to provide a local oscillator signal to the coherent detector 270. This allows for a coherent detection method to be used for LIDAR sensing by the assembly 100.

In the illustrated embodiment, the coherent detector 270 is wafer bounded to the substrate 120. It some other embodiments, it is contemplated that the coherent detector 270 could be optically coupled to the LIDAR chip assembly 200 through a detector-side spot size converter (not shown).

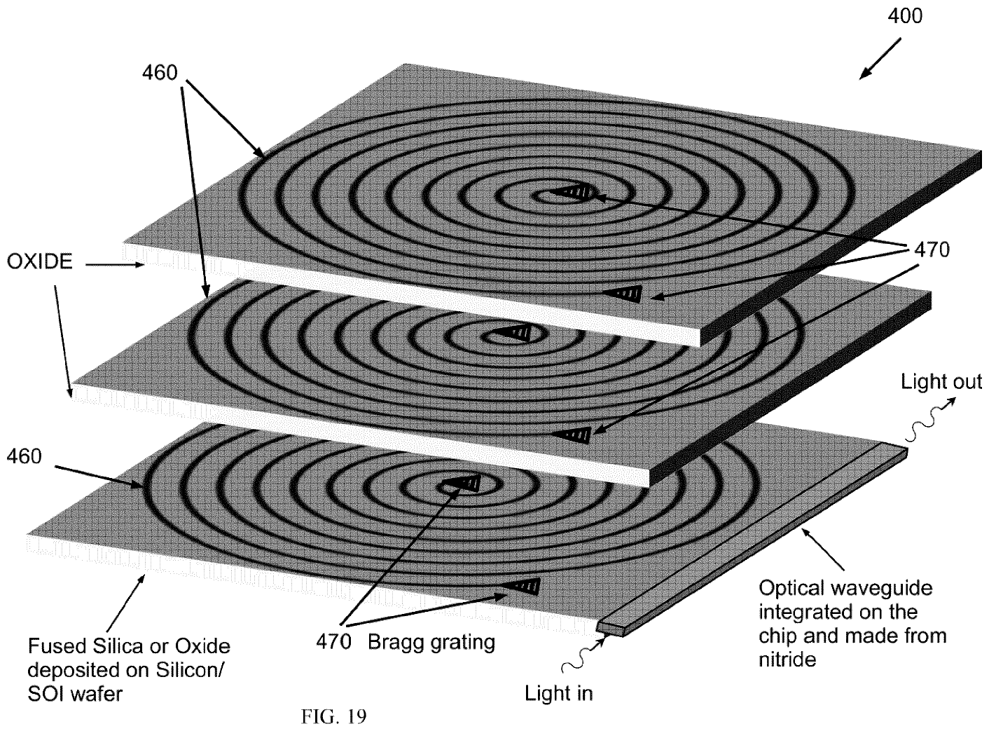

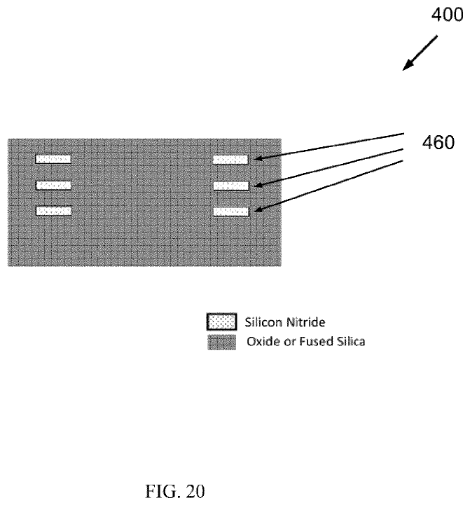

With reference to FIGS. 19 and 20, the optical gyroscope 300 of one or more the LIDAR-gyroscope assemblies 100, 103, 105, 107, 109 (depending on the particular embodiment) includes a stacked spiral ring resonator sensing element 400.

The sensing element 400 includes a plurality of spiral shape ring resonators 460. The resonators 460 are disposed in a stacked configuration. The ring resonators 460 are vertically optically inter-coupled to one another using vertical grating couplers 470. Alternatively, the vertical coupling may also be performed as shown in FIG. 14, with the metal electrodes 256 being omitted. The combination of resonators 460 and couplers 470 then form the sensing element 400 to provide measurement of the Sagnac effect in operation of the gyroscope 300. In at least some embodiments, it is contemplated that the ring resonators could be formed in a circular ring shape or a racetrack ring shape. It is also contemplated that the sensing element 400 could be formed from low loss silicon oxynitride in some cases.

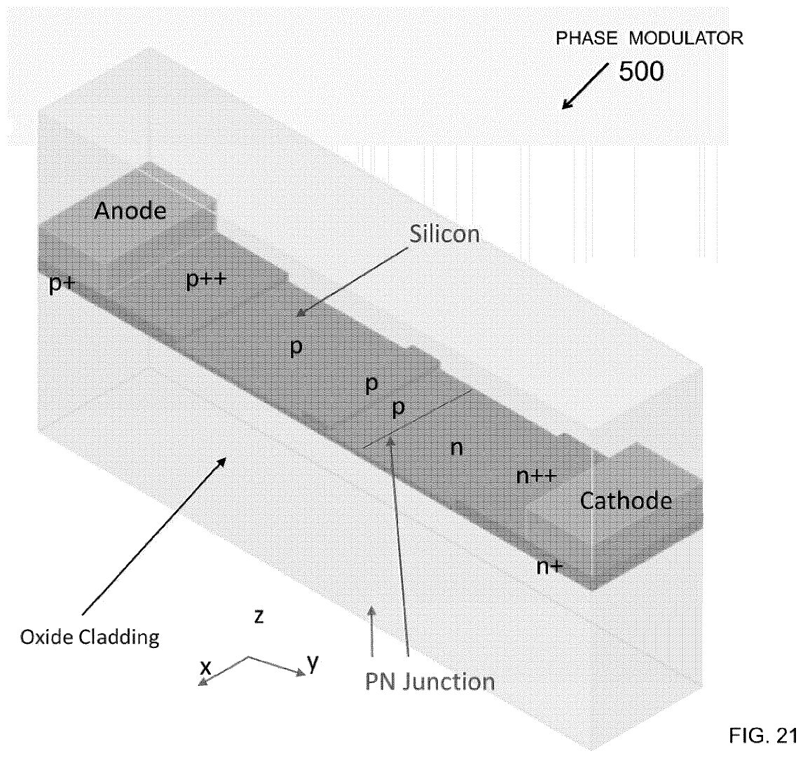

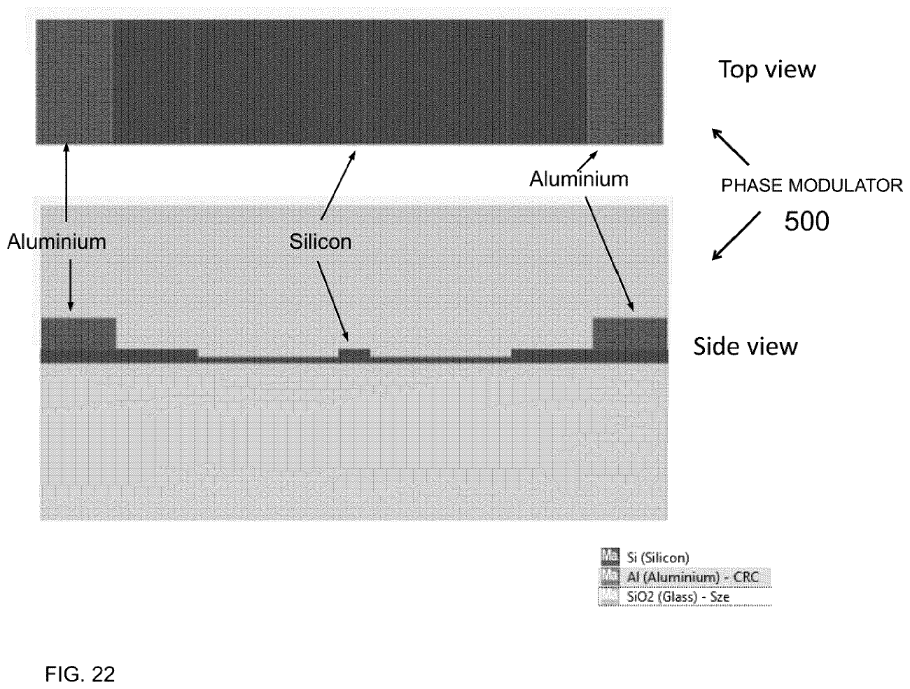

With reference to FIGS. 21 to 24, at least some embodiments of LIDAR-gyroscope assemblies, such as one or more of the assemblies 100, 103, 105, 107, 109, include a phase modulator 500 for selectively controlling the phase of light transmitted therethrough.

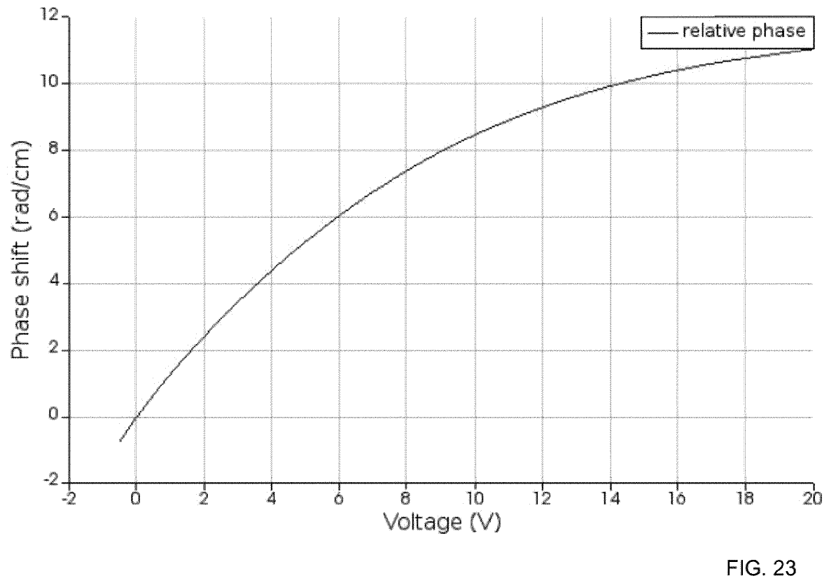

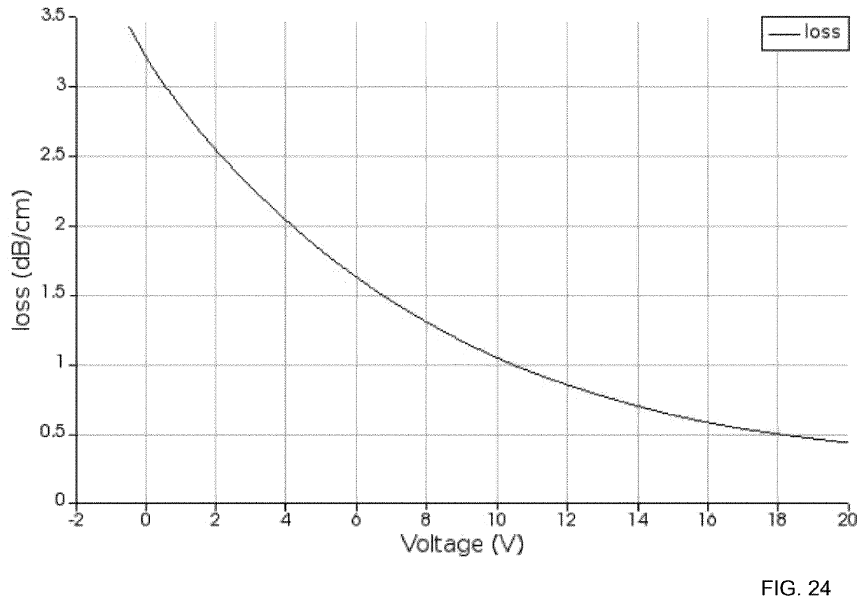

The phase modulator 500 is in the form of a PN-junction structure disposed on an oxide cladding. The PN-junction is formed from doped silicon. The modulator 500 includes electrical contacts, one disposed on each junction barrier (identified as the “Anode” and “Cathode” in FIG. 21). Upon application of an electric potential difference (voltage) across the electrical contacts, light propagating through the phase modulator 500 experiences a phase shift (see FIG. 23). The illustrated structure has been optimized such that high phase shift, but low propagation loss is achieved by increasing applied voltage; see for instance FIGS. 23 and 24.

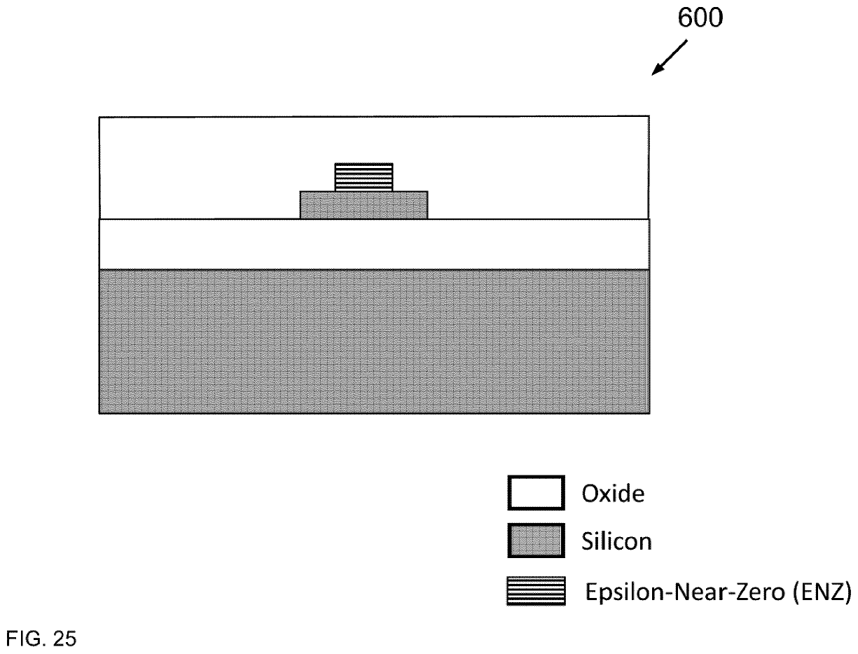

With reference to FIG. 25, at least some embodiments of LIDAR-gyroscope assemblies, such as one or more of the assemblies 100, 103, 105, 107, 109 of FIGS. 1 to 5, include a phase modulator 600 using epsilon-near-zero (ENZ) material for selectively controlling the phase of light.

In silicon photonics, controlling optical phase without changing optical absorption has been mostly pursued electrically. By the present technology, it is proposed to use the light and matter interaction using epsilon-near-zero (ENZ) materials for optical phase control in micro and nano photonic silicon waveguides.

Thermo-optic phase tuning is attained using an ENZ material as a compact, low-propagation loss, and efficient optical heat source. The optical heater (ENZ material) heats up due to the absorbed optical power of the TM polarized mode of the optical beam. The phase shift is achieved for TE polarization using the silicon thermo-optic coefficient and leads to low optical loss due to the pass polarizer operation of the hybrid waveguide section.

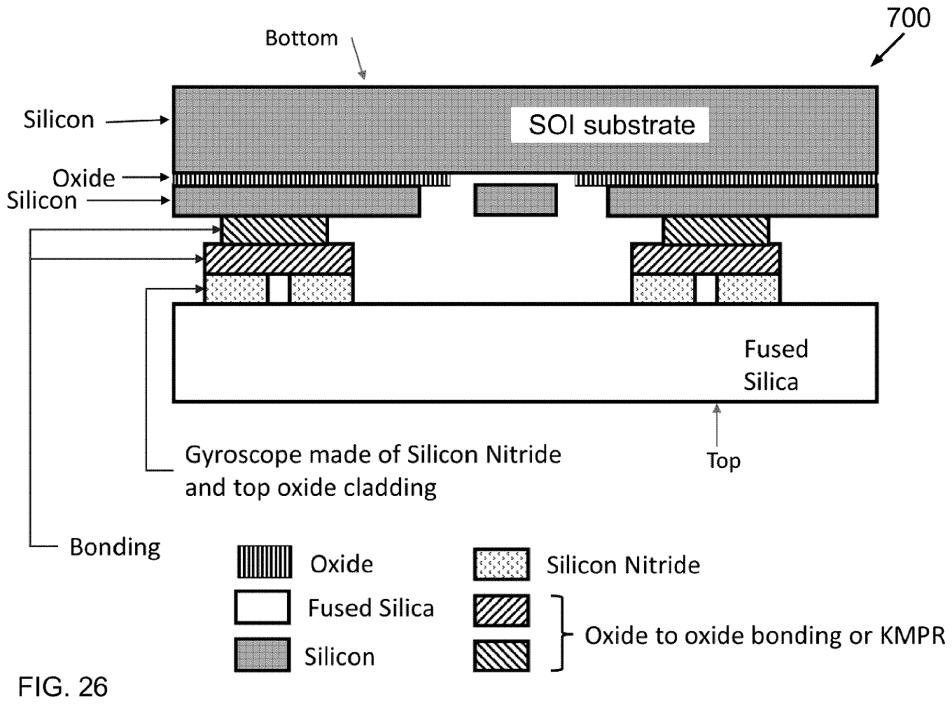

With reference to FIG. 26, an embodiment of a gyroscope 700 is illustrated as connected to the substrate of a LIDAR-gyroscope assembly, such as the assembly 100 of FIG. 1. The optical gyroscope 700 is fabricated of a silicon nitrate and a top oxide cladding deposited and fabricated on a fused silica substrate. In such an embodiment, fused silica is employed to provide the bottom cladding. The gyroscope 700 is then flip-chip bonded to the substrate supporting the full assembly. The SOI substrate could include an accelerometer (U.S. Pat. No. 10,126,321). The flip-chip bonds could be anodic bonding or oxide to oxide bonding or KMPR, depending on the embodiment. The substrate also includes optical elements configured for enabling the gyroscope 700, formed in a silicon layer. These elements in layer include, but are not limited to, phase modulators, circulators, splitters, Mach-Zender interferometer (MZI), multimode interference (MMI) splitters, edge couplers, photodetectors, isolators, and/or one or more accelerometer.

Modifications and improvements to the above-described embodiments of the present technology may become apparent to those skilled in the art. The foregoing description is intended to be exemplary rather than limiting.

1. A LIDAR-gyroscope chip assembly comprising:
a substrate;
an optical gyroscope disposed on the substrate; and
a LIDAR chip assembly disposed on the substrate.

2. The LIDAR-gyroscope chip assembly of claim 1, wherein:
the substrate is formed from silicon;
the optical gyroscope is formed from silicon nitride; and
the LIDAR chip assembly is formed from silicon nitride.

3. The LIDAR-gyroscope chip assembly of claim 1, further comprising:
a frequency modulated continuous wave (FMCW) laser; and
wherein:
the optical gyroscope is operatively connected to the FMCW laser for using the FMCW laser as a gyroscope light source; and
the LIDAR chip assembly is operatively connected to the FMCW laser for using the FMCW laser as a LIDAR light source.

4. The LIDAR-gyroscope chip assembly of claim 3, further comprising at least one power splitter operatively connected between the FMCW laser, and the optical gyroscope and the LIDAR chip assembly for splitting light from the FMCW laser for coupling into a first waveguide optically connected to the optical gyroscope and a second waveguide optically connected to the LIDAR chip assembly.

5. The LIDAR-gyroscope chip assembly of claim 3, wherein:
the at least one power splitter includes at least one 1×2 multimode interference (MMI) coupler; and
the at least one 1×2 MMI coupler is configured to send at least half of laser power received from the FMCW laser to the LIDAR chip assembly.

6. (canceled)

7. The LIDAR-gyroscope chip assembly of claim 5, wherein the at least one 1×2 MMI coupler is configured to split power received from the FMCW laser in at least one of:
an in-plane distribution where the optical gyroscope and the LIDAR chip assembly are disposed in a same plane parallel to a surface of the substrate; and
a split-plane distribution where the optical gyroscope and the LIDAR chip assembly are disposed in different planes parallel to the surface of the substrate.

8. The LIDAR-gyroscope chip assembly of claim 3, wherein the FMCW laser is coupled to the optical gyroscope and the LIDAR chip assembly through the at least one spot size converter.

9. The LIDAR-gyroscope chip assembly of claim 3, wherein the FMCW laser is disposed on the substrate, the FMCW laser being flip-chip bonded to the substrate.

10. The LIDAR-gyroscope chip assembly of claim 3, wherein the FMCW laser is configured to emit light in a wavelength band of about 1500 nm to about 1700 nm.

11. The LIDAR-gyroscope chip assembly of claim 1, further comprising:
a wavelength-stabilized laser disposed on the substrate;
a frequency modulated continuous wave (FMCW) laser disposed on the substrate; and
wherein:
the optical gyroscope is operatively connected to the wavelength-stabilized laser for using the wavelength-stabilized laser as a gyroscope light source; and
the LIDAR chip assembly is operatively connected to the FMCW laser for using the FMCW laser as a LIDAR light source.

12. The LIDAR-gyroscope chip assembly of claim 11, wherein:
the wavelength-stabilized laser is optically coupled to the optical gyroscope through at least one first spot size converter; and
the FMCW laser is optically coupled to the LIDAR chip assembly through at least one second spot size converter.

13. The LIDAR-gyroscope chip assembly of claim 12, wherein the FMCW laser and the wavelength-stabilized laser are disposed on the substrate, the FMCW laser and the wavelength-stabilized laser being flip-chip bonded to the substrate.

14. The LIDAR-gyroscope chip assembly of claim 12, wherein:
the wavelength-stabilized laser is configured to emit light at a wavelength of about 1550 nm; and
the FMCW laser is configured to emit light in a wavelength band of about 1500 nm to about 1700 nm.

15. The LIDAR-gyroscope chip assembly of claim 1, wherein:
the LIDAR chip assembly comprises:
a transmitter phase shifter assembly disposed on the substrate, and
a receiver phase shifter assembly disposed on the substrate;
the transmitter phase shifter assembly and the receiver phase shifter assembly are formed from at least one of:
lithium niobate, and
lead zirconate titanate (PZT); and
wherein the transmitter phase shifter assembly and the receiver phase shifter assembly are configured to be controlled by one of:
thermal tuning; and
electro-optical tuning.

16. (canceled)

17. The LIDAR-gyroscope chip assembly of claim 15, wherein:
at least one of the transmitter phase shifter assembly and the receiver phase shifter assembly comprises a plurality of electrodes;
a plurality of gaps is defined between the plurality of electrodes; and
the plurality of gaps is arranged to reduce voltage overlap between the plurality of electrodes.

18. The LIDAR-gyroscope chip assembly of claim 1, further comprising a coherent detector operatively connected to the LIDAR chip assembly; and
wherein the coherent detector is optically coupled to the LIDAR chip assembly through a detector-side spot size converter.

19.-20. (canceled)

21. The LIDAR-gyroscope chip assembly of claim 1, wherein:
the optical gyroscope further comprises at least one sensing element;
the at least one sensing element comprises a plurality of vertically stacked spiral resonators; and
the plurality of vertically stacked spiral resonators are optically inter-coupled.

22. The LIDAR-gyroscope chip assembly of claim 1, wherein the optical gyroscope and the LIDAR chip assembly are disposed in a same plane, the plane being parallel to a surface of the substrate.

23. The LIDAR-gyroscope chip assembly of claim 1, wherein the optical gyroscope and the LIDAR chip assembly are disposed in a vertically stacked arrangement.

24. The LIDAR-gyroscope chip assembly of claim 23, wherein the LIDAR chip assembly is disposed vertically above the optical gyroscope.

25.-26. (canceled)
